(19) United States
(12) Patent Application Publication
(10) Pub. No.: US 2009/0276207 A1
(43) Pub. Date: Nov. 5, 2009

(54) HOST GREETING CARD

(76) Inventor: Gregory FULTON, Baltimore, MD (US)

Correspondence Address: MICHAEL RIES, 318 PARKER PLACE, OSWEGO, IL, 60543, US

(21) Appl. No.: 12/114,819

(22) Filed: May 5, 2008

(51) Int. Cl. G06F 17/28

(52) U.S. Cl. 704/7

(57) ABSTRACT

Disclosed is a bilingual greeting card where the bilingual card has text in the language of the host country and in the immigrant's language of their foreign country and may celebrate the immigrant's Holiday.

### TECHNICAL FIELD AND BACKGROUND

The present invention relates to a bilingual greeting card. More specifically, the present invention is a to have a bilingual card with the text in the language of the host country and in the immigrant's language of their foreign, transit, immigrant or visiting nationality or the immigrant's Holiday.

The present invention creates a greeting card for nationalist, so they can still feel attached or associated to their country, and at the same time help them to become associated with the host country's language, so it dose not alienated the host country.

### DETAILED DESCRIPTION OF ILLUSTRATIVE EMBODIMENTS

The present invention is a card that celebrities visiting or an immigrant's holidays, and is bilingual. The present invention is a greeting card that is bilingual and celebrates immigrant's holidays. For example you could have a Chinese new year card in English and Chinese that is sold in the United States that may have the bilingual greeting card using the immigrants country's' greetings or some verse related to his or her country, also pictures or images relating to the immigrant's celebration or holiday.

The present invention is used to bridge the language and culture differences that exist in the host countries; of immigrants, through out the world. To also create a better understanding of the holidays and celebrations of other countries and their language.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. An bilingual greeting card comprising:
a first language used throughout the card; and
a second language used thought out the card that is translation of the first language.

2. The bilingual greeting card of claim 1, wherein the card celibates cultural holidays of a country where the first language is common.

3. The bilingual greeting card of claim 1, wherein the card celibates cultural holidays of a country where the first language is common by using pictures and a content of the first language common to the holiday.
